(19) United States
(12) Patent Application Publication
(10) Pub. No.: US 2011/0226962 A1
(43) Pub. Date: Sep. 22, 2011

(54) METHOD AND APPARATUS FOR DETECTING FLUORESCENCE EMITTED BY PARTICLE-BOUND FLUOROPHORES CONFINED BY PARTICLE TRAPS

(75) Inventors: Denis Boudreau, Sainte-Foy (CA); Jean-Francois Gravel, Stoneham (CA); Benoit Voisin, Montreal (CA); Boris Le Drogoff, Montreal (CA); Teodor Veres, Montreal (CA)

(73) Assignee: NATIONAL RESEARCH COUNCIL OF CANADA, Ottawa, ON (CA)

(21) Appl. No.: 12/740,075

(22) PCT Filed: Sep. 25, 2008
(86) PCT No.: PCT/CA2008/001673

§ 371 Date: Apr. 29, 2010

Related U.S. Application Data
(60) Provisional application No. 60/983,408, filed on Oct. 29, 2007.

(51) Int. Cl. G01N 21/64

(52) U.S. Cl. 250/459.1; 250/458.1

(57) ABSTRACT

A method of detecting a fluorescence signal emitted by fluorophores bound to particles confined in a particle trap, includes an objective lens having a focal plane, which is normally the focal plane for incident collimated light. The particle trap is typically located in the focal plane, and a beam of excitation light is directed via the objective lens onto the confined particles in the trap. The excitation light is in the form of a divergent beam coming to focus at a plane displaced from the focal plane. The divergent beam has a spot diameter at the focal plane determined by the divergence of the beam. The fluorescent light emitted by the fluorophores is detected with a confocal detector.

### FIELD OF THE INVENTION

The present invention relates to the detection of signals emitted by molecules bound to particles, and in particular to a method and apparatus for reading the fluorescence signal emitted by fluorescent molecules bound to magnetic particles which are confined in a small volume by means of a particle trap, such as a Micro-ElectroMagnetic Trap (μ-EMT).

### BACKGROUND OF THE INVENTION

In the paper by Lee (Lee et al. 2001), Lee, C. S., H. Lee, et al. (2001). “Microelectromagnets for the control of magnetic nanoparticles.” Applied Physics Letters 79(20): 3308-3310, the possibility of efficiently manipulating and controlling the motion of magnetic particles using microfabricated electromagnets is discussed. These devices not only produce strong local magnetic fields but can also be easily switched on and off by controlling the electrical current that flows through these devices.

Magnetic separation technology based on surface-functionalized magnetic micro- or nanoparticles to selectively bind low-abundance target analytes (DNA, bacteria, virus, and any biologically relevant species) and preconcentrate them to discard the sample matrix prior to their measurement is now widely used. Magnetic particles are commercially available across a wide size range and offer large contact surfaces and functionalized surface densities, thus allowing the optimization of operational and separation procedures with relative ease.

However, the usual analysis procedures typically involve the magnetic separation of particle-bound target analyte from tens to hundreds of microliters of sample solution using permanent rare-earth magnets a few millimeters in size. Following the magnetic separation of the target analyte from the sample matrix, the detection step (generally using sensitive spectroscopic techniques such as fluorescence) can be performed either following the release of the target analyte in a smaller volume or with the analyte still bound to the magnetic beads, Dubus, S., J. F. Gravel, et al. (2006). “PCR-free DNA detection using a magnetic bead-supported polymeric transducer and microelectromagnetic traps.” Analytical Chemistry 78(13): 4457-4464.

Dubus et al. also showed that the combined use of microfabricated electromagnets to effectively manipulate and control the motion of magnetic particles in a liquid media, together with sensitive fluorescence detection, leads to the measurement of minute amounts of particle-grafted target analyte while they are being magnetically confined in the center of a μ-EMT. It has therefore been suggested that such an approach could allow all the stages of a complex analytical procedure to be integrated on a microfluidic chip, which would provide increased throughput and decreased risks of contamination, sample manipulation and reagent consumption, as well as the possibility to perform point-of-care diagnostics and field analysis using a lab-on-a-chip device (also commonly termed Micro Total Analysis Systems, or μTAS). The possibility of efficiently increasing the signal-to background ratio by simultaneously concentrating the particles in space and decreasing the final sample volume while detecting the fluorescence signal offers great potential for the detection of minute amounts of a target analyte in small and complex samples.

The initial approach used to read fluorescence from μEMTs was based on a scanning confocal detection strategy, mainly because of the small dimensions of the μ-EMT (i.e. a few tens of microns in diameter) and the light-scattering nature of the substrates (i.e. multilayered, reflective substrates). This strategy provides several advantages over other optical detection configurations, mostly in terms of axial or depth resolution, which readily translates into better signal-to-noise ratio when substrates are thicker than the optical depth of field. With such an approach, the small detection volume—which scales with the diffraction-limited focal spot (a few microns in diameter) of the focused excitation beam—requires for the whole μ-EMT to be scanned with a high lateral spatial resolution to measure the fluorescence from each of the several magnetic particles that are confined at the center of a μ-EMT. This optical system, while providing an excellent detection limit, also requires a time-consuming scanning step and associated hardware (i.e. high precision translation stages, motors and control electronics), which are major drawbacks.

Other methods have been proposed to either confine or immobilize molecules or particles in a microfluidic unit to enable their sensitive and selective recognition/detection. For example, the paper by Acharya, G., D. D. Doorneweerd, et al. (2007). “Label-free optical detection of anthrax-causing spores.” Journal of the American Chemical Society 129(4): 732-733, discloses the detection of pathogen agents on a sensor surface without the use of magnetic particles. The authors propose an optical biosensor based on the use of immobilized short peptide ligands as specific recognition elements for B. Anthracis spores. The presence of the spores is revealed by measuring the change in transmission of a laser beam through the sensor capture area. However, this detection technique requires time-consuming preliminary procedures (i.e. incubation of the sensor array followed by rinsing and drying steps). Moreover, the sensitivity of absorbance (or transmission) measurements is generally limited and strongly depends on the stability of the source.

Auerswald, J., D. Widmer, et al. (2005). “Fast immobilization of probe beads by dielectrophoresis-controlled adhesion in a versatile microfluidic platform for affinity assay.” Electrophoresis 26(19): 3697-3705, describes an approach consisting in the immobilization of probe beads in defined areas on a chip using dielectrophoresis (DEP)-controlled adhesion. Fluorescent beads were immobilized on electrode pads by nonspecific adhesion. However only a fraction of the beads present in the solution were immobilized to cover the relatively large capture area on the electrodes (more than 200×200 μm wide). The fluorescence signal was collected with an optical microscope equipped with a rather sophisticated detector, i.e. a cooled CCD camera which makes it difficult to decrease the cost and size of the instrument.

Wang, T. H., Y. H. Peng, et al. (2005). “Single-molecule tracing on a fluidic microchip for quantitative detection of low-abundance nucleic acids.” Journal of the American Chemical Society 127(15): 5354-5359, suggests an alternative technique capable of quantitative detection of low-abundance DNA based on confocal single-molecule detection of fluorescence from molecular beacons. The technique is based on the precise confinement of the molecules of interest into a microfluidic channel using electrodes positioned at the channel walls. By applying a specific electrical potential to each electrode, molecules of interest are directed at a given radial position in the channel while they are flowing through it. The overlap between the predetermined path of the molecules of interest and the volume probed by the confocal optical detection apparatus (approx. 1 fL) enables target detection at the subpicomolar level due to a significant reduction of the background signal. However, such a level of detection requires both a sophisticated optical system and a very precise control of electrode potentials, and the possibility to operate such a system with complex samples (i.e. samples containing many different molecular species in different concentrations) has not yet demonstrated.

### SUMMARY OF THE INVENTION

The present invention offers a new approach which will enable the efficient use of particle confinement strategies implemented in detection devices such as point-of-care μTAS diagnostic platforms. This new approach is based on an efficient bead capture system together with a compact, robust, cost-effective, sensitive and rapid fluorescence detection apparatus based on static optical and mechanical components in a single platform.

The present method relies on sample confinement in a small volume with the combined use of particle carriers (paramagnetic or not) and a particle capture system, on the control of fluorescence excitation conditions by means of a specific optical setup to adjust the excitation beam footprint and illuminate the whole volume occupied by the particles, and on the control of detection conditions by means of a specific optical arrangement to selectively and efficiently collect the fluorescence signal and send it towards the detector.

In one embodiment, a confocal fluorescence reader with excitation beam footprint control enables static detection of particle-grafted fluorescent sensors immobilized in miniature particle traps. The system enables an efficient detection without the need to scan either the sample or the optics.

Thus, according to a first aspect of the invention there is provided a method of detecting a fluorescence signal emitted by a sample of fluorophores bound to particles, comprising confining said sample in a particle trap; locating said particle trap in a detection plane; directing a beam of excitation light through an objective onto said sample to trigger the emission of fluorescent light from the sample while controlling the spot diameter of said beam of excitation light in the detection plane to illuminate substantially the whole volume occupied by the sample; and detecting fluorescent light emitted by the sample with a confocal detector.

The excitation beam thus illuminates substantially the entire volume of the confined particles. It will be understood that the expression “substantially the entire volume” means that a sufficient volume to extract a signal without scanning. Of course, it is always possible that a minor portion of the trapped particles might not be fully illuminated, but such a situation is still considered within the scope of the invention.

While not essential, there are advantages in locating the detection plane (trapped particles) at the focal plane. These include the infinity space behind the objective lens, where light coming from the focus travels as collimated beams. Generally, optical filters and dichroic beamsplitters work best at normal incidence or 45° (specifications are for these angles, generally). If the detection plane is moved around the focus, light emerging from the objective will be divergent or convergent with varying angle, and this may cause the analytical performance to be degraded for certain out-of-focus distances.

Moreover, if one wishes to optimize the excitation beam footprint by displacing the detection plane along the excitation axis (which would result in spreading of the spot size of the excitation beam at the detection plane), one also needs to consider realignment of the pinhole/spatial filter+detector assembly of the confocal detector in the X, Y, Z directions, since location of the detection plane image would move accordingly along the optical axis (Z). This is not impossible, but more difficult to perform than having all the detection optical train well aligned for light emerging from the focal plane of the objective lens, and simply altering the divergence of the excitation beam to change the excitation beam spot size at the focal plane. Finally, one also has to consider that light collection efficiency changes when the detection plane moves around the focus.

Beam shaping components can be refractive in nature, such as lenses, in order to control the divergence of the excitation beam. In such a case, the divergent excitation beam comes to focus at a plane displaced from said focal plane, said divergent beam having a spot diameter at said focal plane determined by the divergence of the beam; The beam divergence is normally variable, in which case it can be tuned with a pair of lenses or tunable divergence collimator, example, but it can also be fixed in some applications, in which case a single lens could be employed.

The beam shaping components can also be diffractive in nature, such as diffractive optical element (DOE) or holographic phase masks (HPM). In such a case, precise control of the excitation beam wavefront allows to precisely control the spot diameter at said focal plane, said excitation beam having a spot diameter at said focal plane determined by the DOE/HPM properties;

The confined particles are normally paramagnetic particles in the case where a u-EMT particle trap is being used, but can be paramagnetic or not if a confinement is realized through the use of covalent immobilization of particles on a solid support or through the use of a weir-type trap or a constriction, such as a narrowing of a channel.

According to a second aspect of the invention there is provided an apparatus for detecting a fluorescence signal emitted by a sample of fluorophores bound to confined particles, comprising: a source of a beam of excitation light for triggering fluorescence of said confined particles; a particle trap for said confined particles located in said detection plane; an objective for directing the beam of excitation light onto said particle trap in said detection plane; an optical control element for controlling the spot size of the beam at said detection plane such that substantially the whole volume occupied by said sample is illuminated by said excitation beam; and a confocal detector for detecting fluorescent light emitted by the sample. The spot size should generally be at least equal to the volume of the particle trap, and is generally slightly greater. It could be slightly smaller, although in that case not all of the particles would be illuminated at the same time so the efficiency would be reduced.

In one embodiment, the invention comprises an apparatus for detecting a fluorescence signal emitted by fluorophores bound to confined particles, comprising an objective having a focal plane; a particle trap located at said focal plane; an excitation beam source; a first optical system for directing the excitation beam via said objective onto said confined particles in said particle trap; beam shaping components such that said excitation beam has a spot diameter at said focal plane determined by the intrinsic properties of the beam shaping component (i.e. divergence of the beam, wavefront modifications); a confocal detector; and a second optical system for directing fluorescent light emitted by said fluorophores to said confocal detector.

The present invention is inherently fiber optic-compatible and in one embodiment comprises a light source, an adjustable lens arrangement to adapt the light beam dimensions to the sample geometry, an objective lens to focus the beam into the predetermined volume occupied by the particles and to gather fluorescence emission from said surface, a wavelength separator to extract the fluorescence signal from the excitation light and coupling optics to project the fluorescence image through a confocal aperture to enhance the detection contrast between the fluorescence signal of interest and out-of-focal-plane parasitic light sources such as scattering and autofluorescence.

The present invention also provides a system and a method adapted to the sensitive detection of particle-bound fluorescent sensors immobilized in a particle trap using static (as opposed to moving) optical and mechanical components in a single platform. The present invention can be implemented in numerous ways including as a process, an apparatus, a system, a device or a method.

The benefits of molecular detection using particle-borne fluorescent sensors are best realized by measuring the fluorescence from the particles while they are being confined in a small volume, which decreases the final sample volume and the power requirements from the excitation source. The use of functionalized particles for lab-on-chip devices is then very interesting from a practical point of view, as it is much easier to handle and confine particles than molecules in microfluidic systems. The confinement and motion of the particles can be controlled in different ways. For example, when magnetic particles are being used, by opening/closing the electrical circuit connected to a μ-EMT or by changing the current flowing through the μ-EMT. It can also be accomplished by moving the fluids in the microfluidic unit and thereby directing the particles (which may or may not be magnetic) towards a particle trap (for example, a weir) to enable their confinement in a small volume and at a predetermined location on the microfluidic chip.

The innovative concept of excitation beam footprint control (through divergence control or by means of a DOE) provides benefits for the sensitive optical detection of particle-bound fluorescent sensors immobilized in a particle trap. The first obvious advantage of this approach is the ability to simultaneously and precisely illuminate the inner part of the particle trap, where the particle-grafted fluorescent sensors are confined. Therefore, scanning of the inner surface of the particle trap is no longer needed.

This configuration can also provide a better signal-to-noise ratio through the Fellgett or multiplex advantage, as the fluorescence light will be integrated from all magnetic beads for the entire duration of the measurement (in opposition to rapidly acquiring the fluorescence signal from a much smaller number of beads/molecules while scanning the particle trap and integrating the signals afterwards). For a given excitation power density (in W/cm²) and capable of providing fluorophore saturation, the fluorescence signal should increase with the integration time (T), whereas the noise on the background should increase with the square root of the integration time (T^{1/2}), therefore providing a T^{1/2} increase in terms of S/N ratio.

Moreover, the beam spot size at the focal plane can be precisely controlled and adapted to fit different sizes of particle traps or to precisely fit the surface occupied by the particles into the particle trap, if any smaller than the particle trap itself or the microfluidic features constituting the particle trapping device. The excitation area can be controlled to accurately fill the particle distribution while limiting the interaction with the surrounding environment (i.e. microfluidic channel walls, microfluidic structures, μ-EMT conductor trace on the chip, etc. . . . ) thus preventing excessive scattering of the excitation light.

The overall concept can be assembled in a compact and robust design: there are few or no moving parts (depending on the need to adapt the illumination to one or more particle traps on a single platform, or particle traps with different sizes on a single platform).

The present method encompasses the immobilization and confinement of probe particles at a defined area on a chip using one of several available strategies for which examples have been given previously. The method is fast i.e. it takes from a few seconds to a few minutes to trap particles—depending on the particle size and shape, on the nature/properties of the fluid (i.e. viscosity, temperature, . . . ), on the sample volume and on the trapping/confinement strategy. The method is versatile, i.e., it works for particles with different types of shell coatings (acting as a probe surface) and for different particle sizes.

The present apparatus and its related method are versatile with respect to the nature of the sample. There are no restrictions either on the nature of the fluorescent molecules or on the method to bind the fluorescent molecules onto the particles, or on the nature of the particles. The present method allows for fluorescent molecules to be bound to the particles either before the trapping step (e.g., before the electromagnetic field has been applied), or during the trapping, or after the immobilization of the particles, irrelevant of the nature of the binding. Moreover, binding of the fluorescent molecules to the particles may occur either before, during or after initiation of the detection step.

The present apparatus is detector-independent. Due to its static configuration, the risks of misalignment are minimized, which allows the use of different types of detectors (PMT-type, CCD-type, Si-based such as APDs, SPADs, etc. . . . ). The nature of the experiment and sample will determine the relevant detector technology to be most appropriate.

According to a still further aspect of the invention there is provided an apparatus for detecting a fluorescence signal emitted by fluorophores bound to confined particles and contained in a sample of interest, comprising an excitation light source producing a collimated excitation light beam; an objective having a focal plane; a particle trap located at said focal plane; a microfluidic device incorporating the particle trap and further comprising a fluidic system configured to transport the sample of interest on top of the microelectromagnetic trap; a beam splitter for directing the excitation beam via said objective lens onto said confined particles in said particle trap; imaging optics for imaging fluorescent light emitted by said fluorophores and returned through said beam splitter onto a confocal detector; beam shaping components to enable excitation beam footprint control such that said excitation beam has a spot diameter at said focal plane determined by the intrinsic properties of the beam shaping component.

The beam shaping components can be (but are not limited to) optical components enabling the precise control of the beam divergence such as a pair of lenses with adjustable separation, a tunable divergence collimator, including an optical fiber collimator to provide adjustable divergence, or it can be a single element, such as a lens providing a fixed divergence or a diffractive optical element enabling the generation of the desired beam footprint at the focal plane of the objective through the control of the excitation beam wavefront.

The focal plane is normally the focal plane for incident collimated light.

The sample of interest is typically a small-volume liquid solution (such as water) containing a suspension of particle-bound fluorophores.

The fluidic system can be composed of a variety of microchannels, wells, reservoirs/chambers, which are preferably located on top of the microelectromagnetic trap with dimensions substantially equal to the microelectromagnetic trap diameter. One suitable microchannel tested was 100 microns wide×20 microns high.

The fluidic system can also comprise a means of transporting fluids through the device (including injection, pumping, applied suction, capillary action, osmotic action, thermal expansion, contraction, etc.) to cause the liquid-suspended particle-bound fluorophores to flow in the microfluidic channel on top of the microelectromagnetic trap. A syringe-pump was tested and found to be useful.

The substrate supporting the microchannel/well/reservoir/chamber located on top of the microelectromagnetic trap is preferably a transparent material at the excitation and fluorescence wavelengths.

The particle trap is preferably located near one surface of the fluidic system and the microchannel/well/reservoir/chamber is located towards the inner part of the fluidic system. For example, microelectromagnetic traps deposited on a thin glass plate (less than 1 mm) covered by a fluidic part made of PDMS (poly dimethyl siloxane), 1 cm thick, were tested and found useful to provide fluidic connections.

Any reference to light in the present specification includes non visible light, such as infra red or ultraviolet light.

It will also be understood that the terms top, over, bottom, and under do not necessarily imply geometrical orientation, but describe the function of the related elements. Thus, for example, a plate covering a chamber is considered to lie over that chamber regardless of the actual orientation.

### BRIEF DESCRIPTION OF THE DRAWINGS

The invention will now be described in more detail, by way of examples only, with reference to the accompanying drawings, in which:

FIG. 1 is a schematic side view of a first embodiment of a fluorescence reader system;

FIG. 2 shows a closer view of the optics scheme used to characterize the effect of a specific combination of lenses and separation on beam waist variation (i.e. beam radius measured at 1/e²) along the optical axis of the focusing optics (e.g. objective lens);

FIG. 3 shows plots of the excitation beam waist variation (i.e. beam radius measured at 1/e²) along the optical axis of the focusing optics (e.g. objective lens) for a collimated beam and a divergent beam input, where divergent beam input is realized with a specific combination of lenses and separation;

FIG. 4 shows the excitation beam waist variation (i.e. beam radius measured at 1/e²) at the focal plane (8) of the focusing optics (e.g. objective lens) as a function of the separation distance between lenses, thus establishing the ability of the fluorescence reader of FIG. 1 to provide a wide range of excitation beam diameter;

FIG. 5 illustrates the CAD optical layout of the propagation of a collimated input light beam through the objective lens as depicted in FIG. 2, upper diagram;

FIG. 6 is an optical CAD spot diagrams at the focus plane in case of a collimated input light beam;

FIG. 7 illustrates the CAD optical layout of the propagation of a divergent input light beam through the objective lens, as depicted in FIG. 2, lower diagram;

FIG. 8 is an optical CAD spot diagram at the focus plane in case of a divergent input light beam;

FIGS. 9a and 9b illustrate a microfluidic system, wherein FIG. 9a is a top view of the system shown in FIG. 9b (note that FIG. 9a does not show the optical setup, for clarity).

FIG. 10 is a schematic representation of a particle-grafted target analyte;

FIG. 11 is an image of particles trapped on the p-EMT;

FIG. 12 shows typical results obtained from an experiment described in the examples;

FIGS. 13A to C are different views of a microfluidic system showing a combination of two different particle trapping strategies, namely a μ-EMT and a weir;

FIG. 14 is a side view of the microfluidic system together with the optical detection setup;

FIGS. 15A to 15C are photographs and schemes of the particle trapping approach shown in FIGS. 13A to 13C;

FIGS. 16A to 16C are different views of a microfluidic system having a weir as a particle trapping;

FIG. 17 is a side view of the microfluidic system shown in FIGS. 16A to 16C together with the optical detection setup;

FIG. 18A is an image showing the confinement of 20 microns diameter (non-magnetic) dye-grafted particles using a weir in a microfluidic channel together and FIGS. 18B and 18C are graphs showing the fluorescence signal acquired across the trapped particles in the X and Y dimensions, respectively.

FIG. 19 shows the results for the detection of genomic DNA from a sample containing gram positive bacteria using 2.8 micron diameter magnetic particles.

FIG. 20 shows the results for the detection of genomic DNA from a sample containing endospore-forming bacteria using 2.8 micron diameter magnetic particles.

### DETAILED DESCRIPTION OF THE EMBODIMENTS

As explained above, the present invention encompasses an alternative illumination/excitation and fluorescence detection apparatus based on the control of the excitation beam footprint dedicated to the detection of particle-grafted fluorescent sensors immobilized in microfluidic devices incorporating a particle trap.

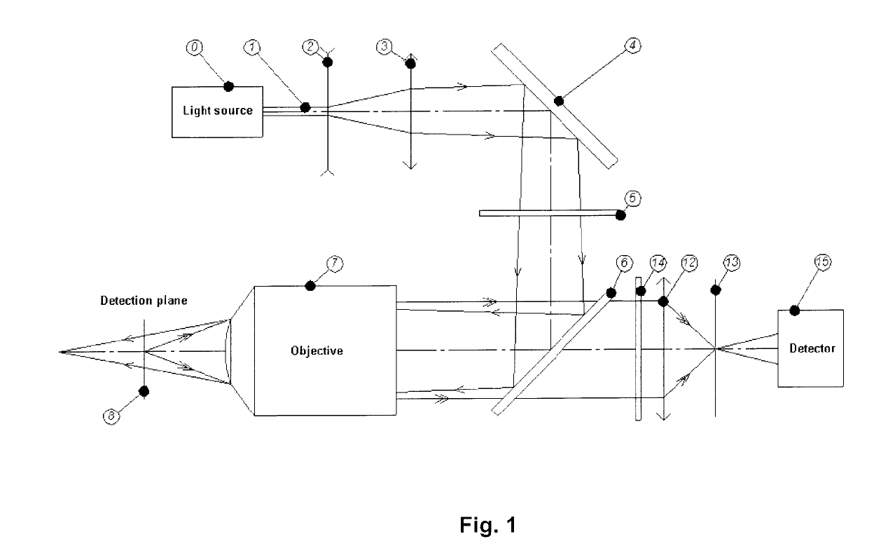

In FIG. 1, a light source 0, typically a laser, emits a light beam 1 for exciting fluorophores bound to particles. A lens pair 2, 3 with respectively negative and positive focal lengths is arranged on an optical path of the light beam emitted 0 from the light source 1 to induce and control the divergence of the beam 1. It will be appreciated that other suitable configurations for diverging the beam 1 can be employed. For example, it is possible to employ an arrangement of two lenses with positive focal lengths similar to that used in a Keplerian telescope.

The excitation beam 1 is then spectrally cleaned by means of a narrow bandpass filter 5 centered on the emission wavelength of the source. The divergent beam strikes a beamsplitter 6 used as a wavelength divider. The beamsplitter 6 reflects the excitation beam wavelength from the light source 0 and transmits the appropriate wavelength range overlapping the fluorescence emission band of the analyte, which is located in the detection plane 8.

The deflecting element 4, which can be in the form of a deflection mirror, can be added into the excitation beam path. However, care must be taken to ensure that the path between the lens pair 2,3 and the focusing optics 7 is made short enough to avoid the outer part of the diverging beam from overfilling the objective/focusing optics 7, which would result in a risk of increased reflections/scattering in the system and therefore degrade the analytical performance.

The excitation light is focused on the particle trap by means of a multi or single-element objective lens 7. In an alternative embodiment, it will be appreciated by one skilled in the art that the objective lens 7 could be replaced by a concave mirror system, in which case of course the concave mirror would be located on the opposite side of the trap. In the embodiment shown, the sample is located at the focal plane 8 of the objective lens 7. Fluorescence emitted by particle-grafted fluorescent sensors or fluorophores is collected by the objective lens 7 and coupled into an aperture 13 by means of an imaging lens 12. Because the sample is located in the focal plane 8 of the objective lens, the light returned from the objective lens toward the imaging lens 12 appears as a collimated beam, and is focused onto the aperture 13 by the imaging lens 12.

The confocal detection concept is preserved in this configuration wherein the particles confined in the particle trap are located at the focal plane 8 of the objective lens 7. This configuration has several advantages. First, the light collection efficiency is maximized since it occurs at the focal plane of the lens 8. Second, by locating the sample at the focal plane of the optics, the fluorescence emerges as a flux of parallel rays (because the particle trap inner area is considered an extended object rather than a point source) from the back aperture of the objective lens (in the so-called infinity space). Optical alignment with the detector is made very simple, since these parallel light rays can be focused to create an image of the focal plane 8 (i.e. the particle trap inner area) by placing a lens 12 in the infinity space. Selection of an appropriate position for lens 12 in the infinity space allows one to include various optical elements (such as filters, mirrors, polarizers, etc. . . . ) with very little effect (or no effect at all, assuming a properly aberration-corrected objective lens) on the subsequent image position. It also ensures that light collected at the periphery of the μ-EMT is gathered by lens 12 and reaches the detection system. Finally, selection of an appropriate focal length for the focusing lens 12 allows one to adjust the magnification of the image in such a way that a small aperture (such as a pinhole or optical fiber) precisely aligned at the focal plane 13 of the focusing lens 12 will act as a spatial filter to block out-of-focus light as well as light located outside the center of the particle trap (for example, light scattered off microfluidic structures such as channel walls).

In one embodiment the invention includes a measurement apparatus comprising the light source 0 for the excitation of particles confined in the center of a particle trap, a specific lens-based system 2, 3 to adjust the beam footprint to the particle trap dimensions, a filter 5 centered on the excitation wavelength, a dichroic beamsplitter 6 which reflects the excitation beam and transmits the fluorescence light, an objective lens (single or multielement) 7 which focuses the excitation light on the particle trap and gathers fluorescence light emitted by the target analyte, an imaging lens 12 which projects the image of the excited surface in the particle trap with an appropriate magnification onto a small aperture 13 (or confocal aperture, such as a pinhole or optical fiber) placed at the focal plane of lens 12. The aperture 13 acts as a spatial filter to reject out-of-focus light and light located outside the center of the particle trap (for example, light scattered off microfluidic structures). The magnification of the optical system (comprising objective lens 7 and focusing lens 12) can be calculated, and by suitable selection of lens 12 focal length and aperture 13 diameter, the size of the image can be adjusted to the size aperture to reject parasitic light.

Another advantage of the configuration shown in FIG. 1 is that the spot size dimension in the focal plane 8 can be adjusted by controlling the divergence of the beam with lenses 2 and 3 while keeping the sample in the focal plane 8 of the objective lens 7, rather than moving the sample around the focal plane, which would result in the need to realign the lens 12 with respect to aperture 13 every time such a change is made. The preferred configuration gives great robustness and flexibility to the system.

The light passing through the aperture 13 is sensed by the detector 15. An optical bandpass filter 14, centered on the fluorescence wavelength, is located upstream of the aperture 13. The spatial filtering could be accomplished without a confocal aperture if one uses, for example, a multichannel detector such as a CCD providing sufficiently small sensor elements (i.e. pixels) to enable the spatial discrimination of the signal of interest.

Although the detection place 8 is preferably located in the focal plane of the objective lens 7 as described, it will be understood that this is not essential. The detection plane 8 could be displaced, in which case the return beam of fluorescent light will be divergent or convergent, but such departure from collimation can be compensated for by suitable optics.

The objective lens 7 should have relatively short depth of focus in order to discriminate the fluorescence signal from the background signal caused by scattering of the light from the multilayered μ-EMT structure. The focusing optics 7 should offer a large light collection angle or numerical aperture to improve the collection efficiency. The excitation light source 1 should have sufficient illumination power at the objective lens focus. The light source output beam 1 should be well collimated (or one should be able to properly collimate the excitation beam with suitable optics).

The excitation light source intensity can be fine-tuned, according to the absorption coefficients and emission lifetime of the fluorescent molecule, to prevent them from photodegradation (photobleaching). By doing so an optimum fluorescence emission with minimal background emission is obtained.

The system is inherently fiberoptic-compatible. Thus, the light source 0 can be coupled to an optical fiber to convey the light towards the lens pair 2,3. In the case of a fiber coupled light source whose output is terminated with a collimator, the optical setup can benefit from a dramatic decrease in size. The role of the lens pair 2,3 can be performed by a tunable divergence collimator, which would include an optical fiber collimator. It is known that optical fibers may be used as confocal apertures (i.e. spatial filters) in confocal microscopes. Dabbs, T. and M. Glass, Fiberoptic Confocal Microscope—Focon. Applied Optics, 1992. 31(16): p. 3030-3035. Thus an optical fiber core can be used as a confocal spatial filter 13. The SNR can be optimized by modifying the input fiber core diameter. According to the imaging magnification of the lens pair 7 and 12 which projects the image of the excited surface in the particle trap onto the fiber input (located at 13), one can balance fluorescence light collection and background light rejection (out-of-focus light and light located outside the center of the particle trap).

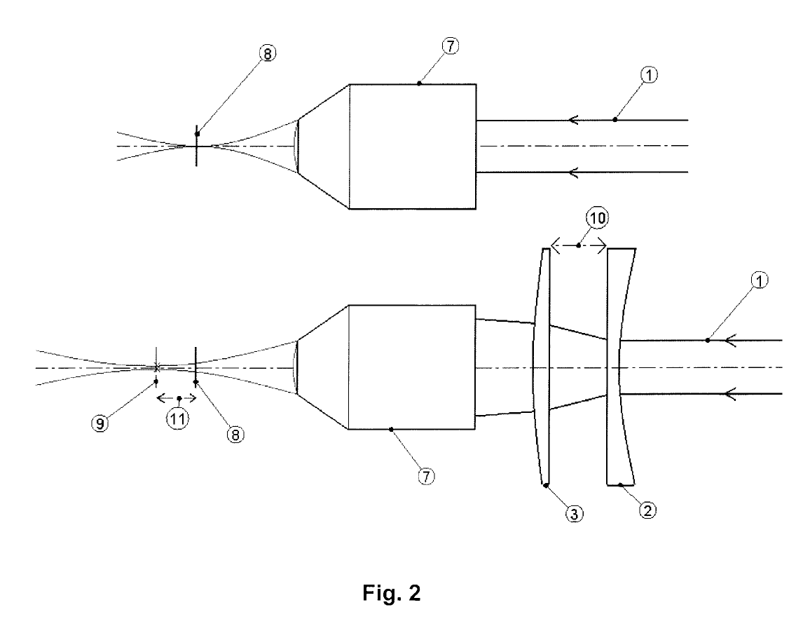

FIG. 2 illustrates in schematic form the novel beam divergence control method. The return beam is not shown in FIG. 2. In the presence of a well collimated beam 1 which passes through the objective lens 7, the focus point is located at the focal plane 8 of the objective lens 7. The addition of the lens pair 2, 3 separated by a specific distance 10 not only forces the output light beam to diverge but also displaces the focal plane by a distance 11. While the beam spot is nearly diffraction limited at plane 9, the beam footprint located on the detection plane 8 is directly linked to lens pair separation 10. This principle is applied in the apparatus of FIG. 1 to control spot size at the focal plane 8.

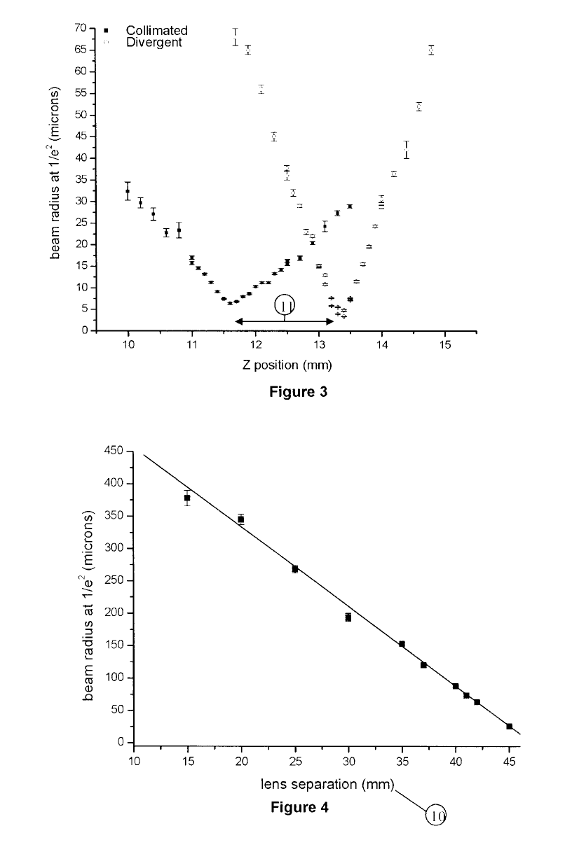

The plot in FIG. 3 compares the beam footprint (i.e. beam radius measured at 1/e²) of a divergent and collimated beam along the optical axis of the objective lens 7. Realized by using the knife-edge (or beam occultation) method to characterize the beam diameter at different axial locations (Z-axis), FIG. 3 and FIG. 4 provide an efficient method to calculate the plane shift 11 and the relationship between the lens separation 10 and the beam footprint at plane 8. Thus it is possible to illuminate the whole particle trap while keeping a collimated fluorescent beam for the detection.

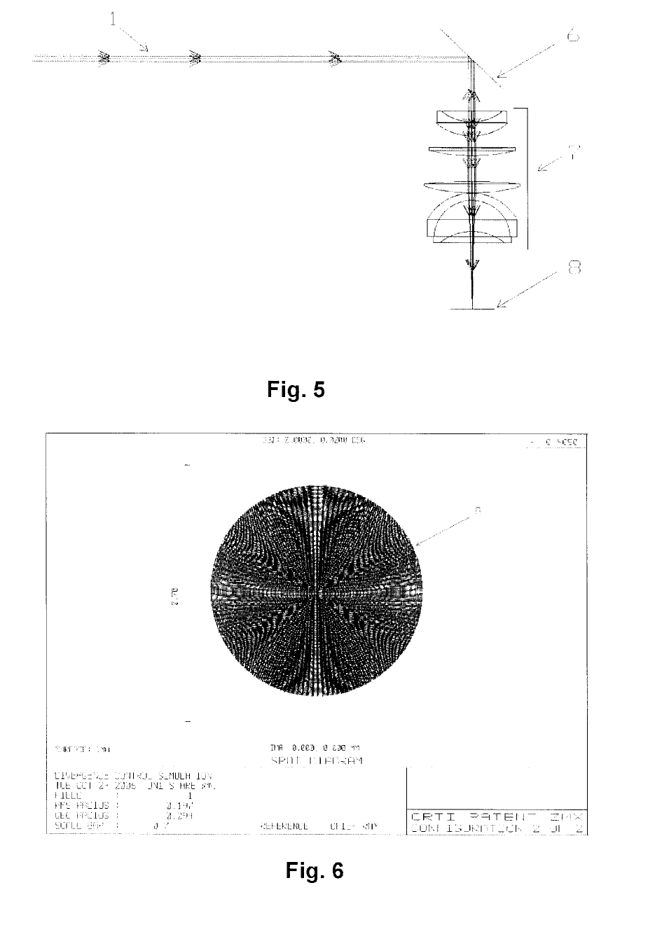

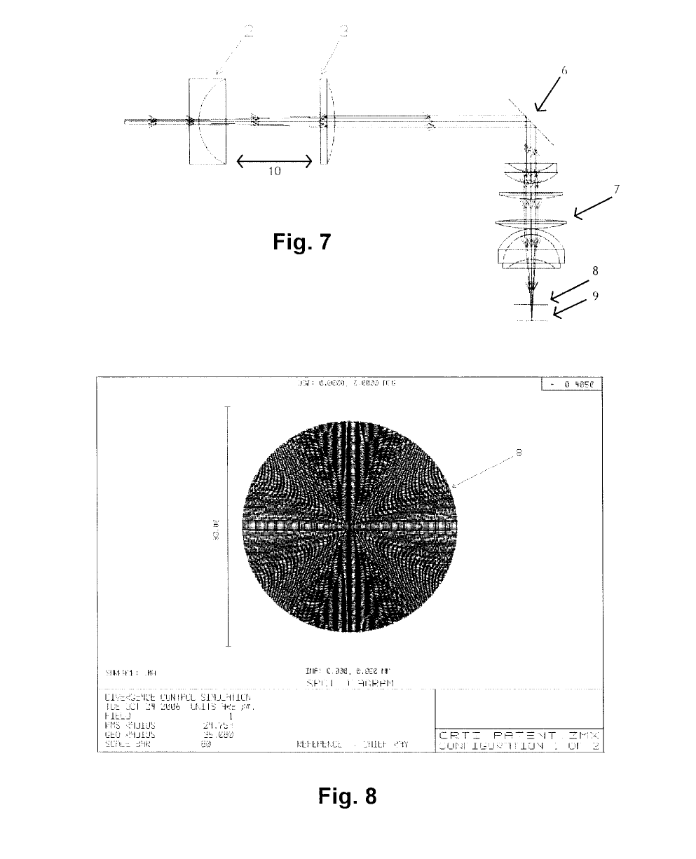

FIGS. 5 to 8 are optical simulations of the divergence control concept. One can observe that, given an appropriate separation 10 between the lens pair 2 and 3, the beam waist (FWHM or Full Width at Half Maximum) at the plane 8 (75 μm) is equivalent to the diameter of a particle trap that has been tested (i.e. μ-EMT having 75 μm in diameter). A proper control of the beam footprint ensures that the excitation efficiency is maximized while limiting the interaction with the surrounding environment (i.e. microfluidic channel walls, microfluidic structures, μ-EMT conductor trace on the chip, etc. . . . ) thus preventing excessive scattering of the excitation light. It should be noted that, for a Gaussian intensity distribution, a direct correlation exists between beam radius at 1/e² and beam waist at FWHM: beam radius at 1/e²=0.85 FWHM. Therefore one can select experimental parameters that allow the choice and evaluation of the amount of energy deposited into the surface area of interest.

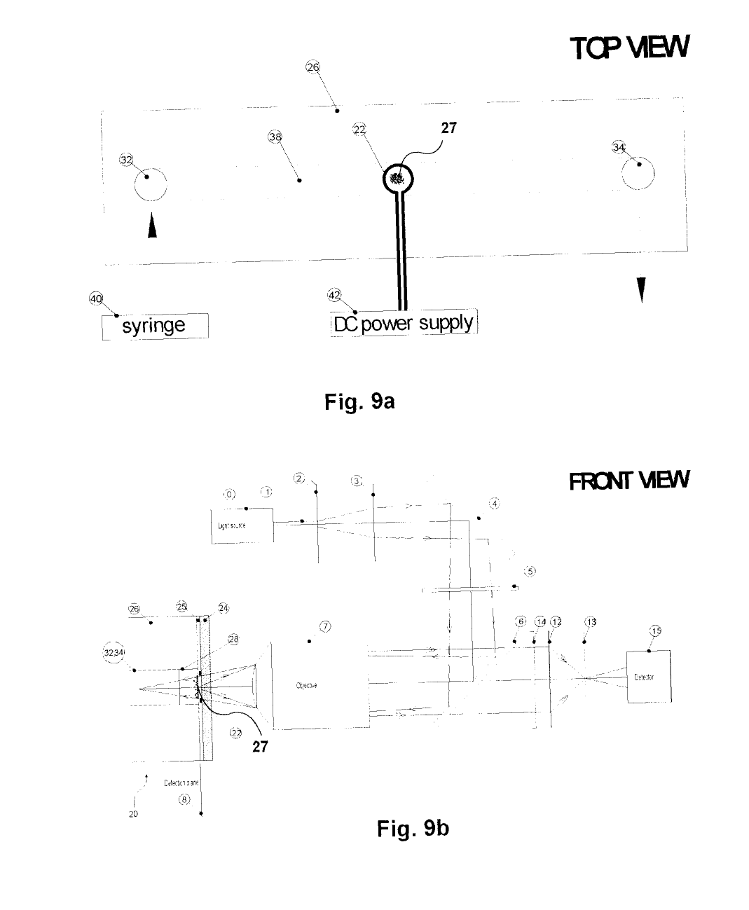

FIG. 9b shows a fluidic device 20 incorporating a microelectromagnetic trap (μ-EMT) 22 containing the sample under investigation associated with the basic setup shown in FIG. 1. A thin layer 25 of PDMS (35 microns in this example) is deposited between a thin (less than 1 mm thick) glass plate 24 and a thick (1 cm in this example) PDMS substrate 26. The trap 22 is deposited on glass plate 24 and is incorporated in the layer 25, which serves both as an insulator and a spacer to position the sample in a region where the magnetic field is oriented perpendicular to the plane of the trap. Fluid chamber 28 is formed in the substrate 26 over the trap 22. The trapped particles 27 are located at the center of the microelectromagnetic trap 22.

FIG. 9a is a plan view showing microfluidic channel inlet 32, outlet 34, microfluidic channel 38 and microelectromagnetic trap 22. The power supply 42 provides the power to the trap 22. Syringe 40 is used as a pump to inject fluid into the inlet 32.

The excitation beam and fluorescence collection beam are located on the thin side of the fluidic device 20 (i.e. from “under” the trap—on the right of the fluidic device). Such a configuration avoids excessive interaction of the excitation and/or fluorescence light with the bulk material and avoids excitation and/or fluorescence light beam diversion at the microfluidic structures (ex. microchannel, well, reservoir, chamber, wall, surfaces, etc.) that could degrade analytical performance and that make alignment of the microelectromagnetic trap with the optical system more difficult.

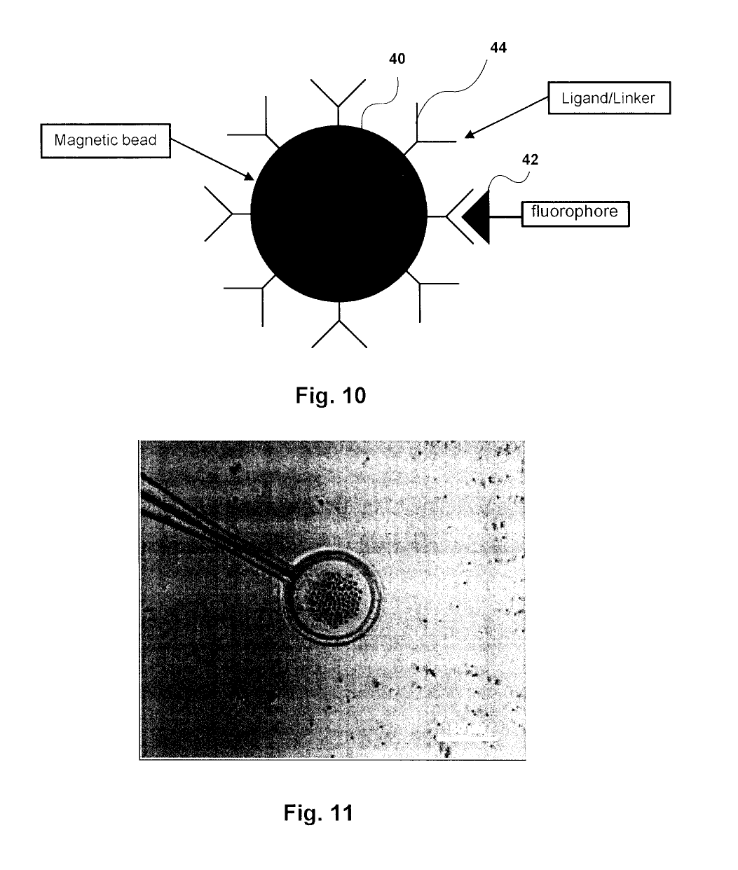

FIG. 10 illustrates general mechanism of the binding of fluorescent dye onto particles. A fluorophore 42 is attached to magnetic bead 40 by means of a ligand/linker 44.

FIG. 11 is a photograph of the μ-EMT particle trap and of the immobilized paramagnetic particles in its center when illuminated with visible light using a method in accordance with an embodiment of the invention. This validation procedure can be implemented to ensure a proper alignment between the fluorescence reader and the μ-EMT before starting an experiment.

FIG. 12 shows the results obtained from the experiment described in Example 1 and the setup shown in FIG. 9b. The graph on the top shows the background signal of uncoated trapped beads; the signal observed is mainly due to light reflected off the solid substrate. The graph on the bottom shows the signal measured for beads coated with Lucifer Yellow (LY). The use of beam footprint control allows fluorescence detection of as little as a few tens of particles loaded with LY at 10⁻¹⁷ mole level within a short period of time (around 5 minutes).

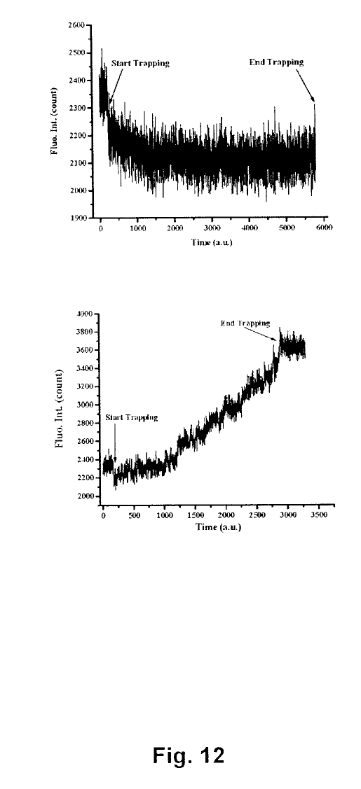

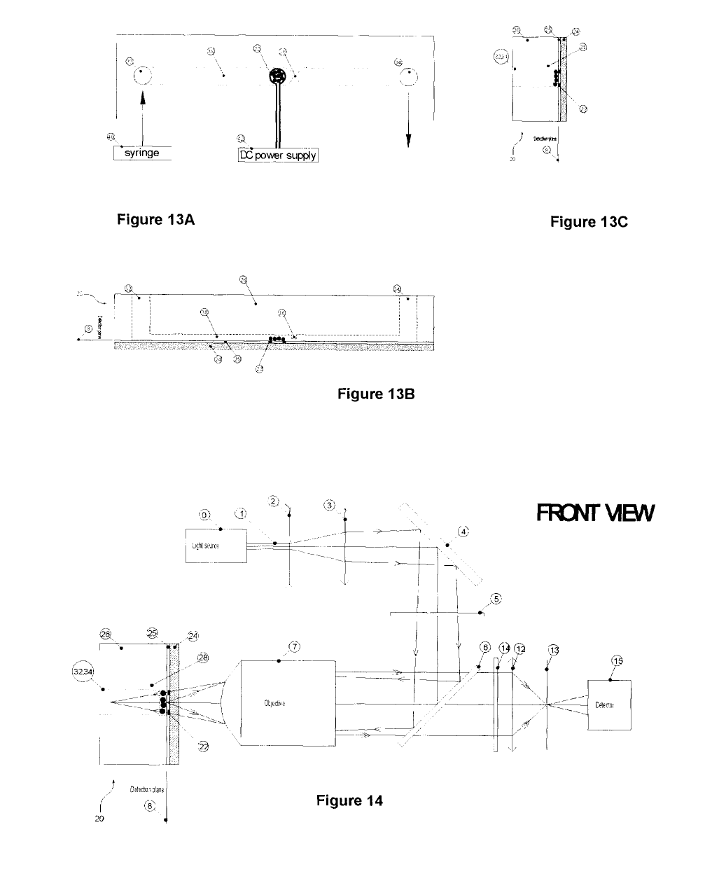

FIG. 13a illustrates a microfluidic system 20 (different views) showing a combination of two different particle trapping strategies, namely a μ-EMT 22 and a weir 36. The arrangement of the material layers 24,25,26 is the same as described for FIG. 9b. However, narrowing 36 of the microfluidic channel height 38 occurs downstream of the μ-EMT 22 (with respect to fluid flow determined by microfluidic channel inlet 32, outlet 34) to create a weir to trap particles. The shallow space that is left under the weir enables the fluid to pass, but its height is smaller than the diameter of the particles of interest. Therefore, other species (atoms, ions, molecules, debris, etc. . . . ) contained in the fluid can be separated from the analyte species grafted on the particles, enabling a better control on the sample matrix and associated risks of interferences (inhibition, fluorescence quenching, non-specific interactions, etc. . . . ).

A combination of the two particle trapping strategies can be useful in particular when the particles are small and experience a high viscous drag from the fluid flow with respect to the magnetic force generated by the μ-EMT, making them difficult to capture and immobilize in fluid flows compatible with the processing of sample volumes of a few microliters within a few minutes (e.g. μ/L/min of water). Working with a low amount of beads enables one to avoid diluting the analyte over a large number of beads, which can be critical when the total number of target analyte molecules is very low. However, to be able to detect a minute amount of sample on a small number of beads, one also has to avoid excess scattering or any contribution to the background signal. Confinement of the few beads at the center of a μ-EMT provides another supplemental advantage in terms of detection contrast (instead of probing the beads at the weir location, where multilevel microfluidic structures are found). In this case, sequential trapping of the beads was tested and found to be useful (i.e. trapping in the weir with μ-EMT inactivated, then trapping in the μ-EMT prior to the detection step).

FIG. 14 is a side view of another embodiment of the microfluidic system together with the optical detection setup. As described with reference to FIG. 9B, the preferred configuration involves having the excitation beam and fluorescence collection beam located on the thin side of the fluidic device 20 (i.e. from “under” the trap).

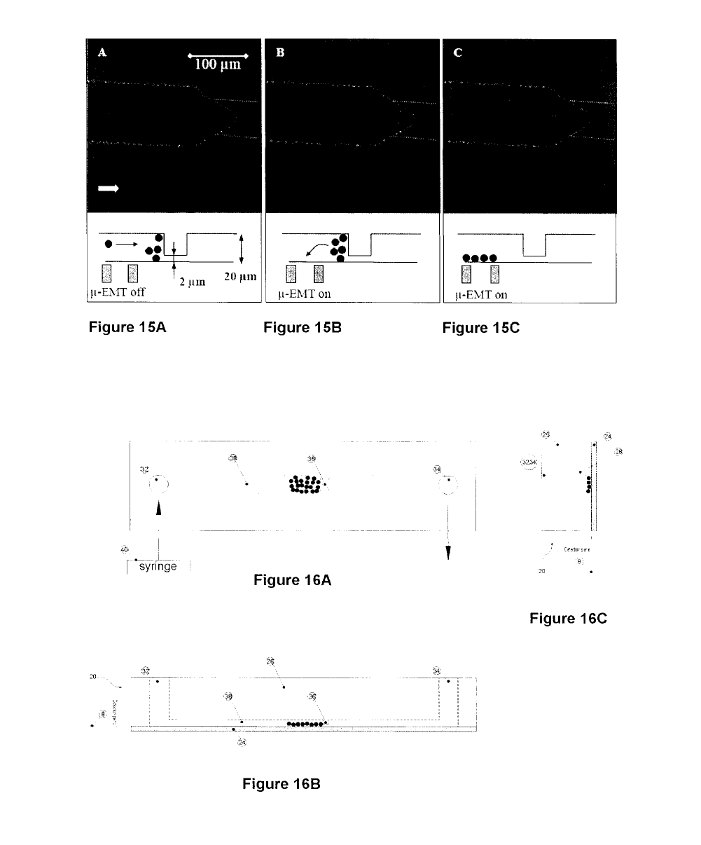

FIGS. 15A to 15C are photographs of the particle trapping approach described in FIG. 14, accompanied by descriptive schemes. In FIG. 15A, small magnetic particles of 2.8 microns in diameter are trapped in a weir (2 microns in height) while the solution is flown in the microfluidic channel (100 microns wide, 20 microns high). The g-EMT is inactive at this stage. In FIG. 15B, the fluid flow is stopped and the μ-EMT is activated, enabling confinement of the magnetic particles at the center of the μ-EMT. In FIG. 15C, the fluid flow is still stopped, the μ-EMT is still activated and fluorescence detection can be performed on the confined particles at the center of the μ-EMT.

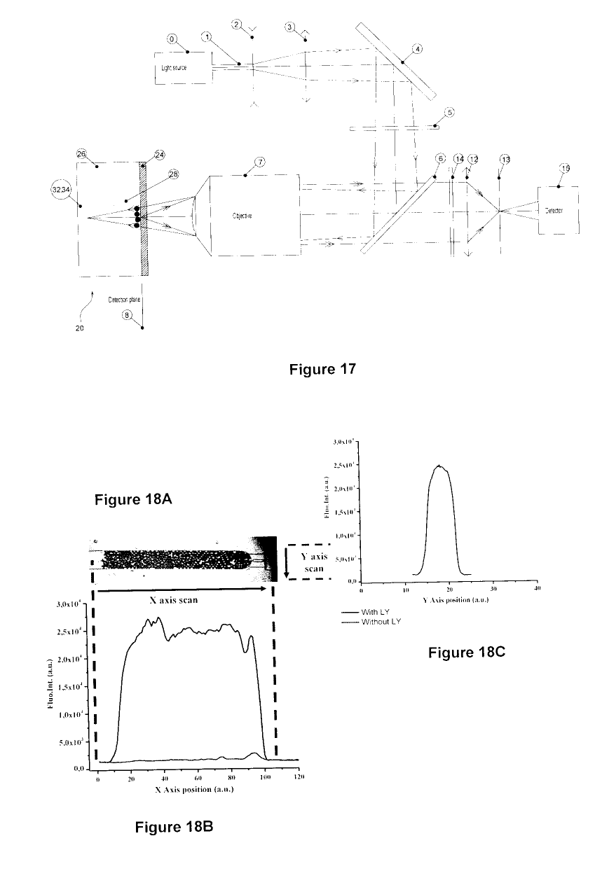

FIGS. 16A to 16C and FIG. 17 illustrate a microfluidic system 20 (different views) having only a weir 36 as a particle trap, similar to that shown in FIG. 14. Arrangement of the material layers differs from FIGS. 9 and 13. Since there is no μ-EMT, insulating and spacer layer 25 is not needed, which simplifies the design and production of the microfluidic devices. The thick substrate 26 (1 cm PDMS in this example) bearing the microfluidic features (channels, weir, etc. . . . ) is deposited on top of a thin (less than 1 mm thick) glass plate 24. As described with reference to FIG. 14, narrowing 36 of the microfluidic channel height 38 occurs downstream of the μ-EMT 22 (with respect to fluid flow determined by microfluidic channel inlet 32, outlet 34) to create a weir to trap particles. The shallow space that is left under the weir enables the fluid to pass, but its height is smaller than the diameter of the particles of interest. This design has been shown to be useful for the use of larger non-paramagnetic particles, in particular where a relatively high number of beads can be used in the particle trap. Note that paramagnetic particles could also be trapped by such an approach.

The use of larger particles enables one to design the weir with a corresponding increased height, therefore enabling one to use higher flow rates, processing larger sample volumes or reducing process time. Moreover, providing a particle diameter with a narrow size distribution, channel height can be designed in such a way that particles are packed on a single layer in the particle trap (i.e. height <2×particle diameter), therefore maximizing the interaction of particles surface with the excitation beam.

If the target analyte in the sample is concentrated enough to allow for the use of a relatively large number of probe particles (resulting in increased sample dilution, but not below the satisfactory quantification level of a given measurement), the greater surface covered by the trapped particles can contribute to increase the robustness and decrease the level of complexity of the experiments, providing that the probed surface is significantly larger than the bead diameter (which allows for the measurement of a statistically relevant number of particles), bead packing in the particle trap is relatively uniform, and the positioning accuracy of the microfluidic device with respect to the optical system allows for the totality of the probed surface to overlap with trapped particles without scanning or moving the sample or requiring sample position optimization based on a feedback mechanism (ex. alignment marks, alignment device, position sensors, etc. . . . )

If the previous conditions are met, the number of probed particles in the excitation beam will be relatively constant.

Since the particles can significantly contribute to the background signal (ex. scattering, autofluorescence of particle's coating materials, fluorescence of surface ligands, etc. . . . see FIG. 18B (graph), trace label “Without LY”), one has to normalize the background signal to the number of particles to avoid misinterpretation of the analytical results. For instance, a large number of beads without grafted analyte could produce a signal equivalent in magnitude to a lower number of beads grafted with a few fluorescing target analyte. Difference or background subtraction would therefore result in an erroneous conclusion with respect to the presence (or concentration) of the target analyte in a sample. A solution to this problem involves the evaluation of the number of probed particles, which might be difficult and complex to implement (for example in portable and compact detection systems). A better and simpler approach involves controlling the number of particles to be probed. Having an excess of particles is certainly the easiest way to implement the latter approach, when analytical conditions and sample concentration are suitable.

FIG. 17 is a side view of the microfluidic system together with the optical detection setup. As described previously with reference to FIGS. 9B and 14, the preferred configuration involves having the excitation beam and fluorescence collection beam located on the thin side of the fluidic device 20 (i.e. from “under” the trap).

FIG. 18A contains an image showing the confinement of hundreds of 20 microns (silica core, non-magnetic) LY-grafted particles using a weir (18 microns in height) in a microfluidic channel (200 microns wide, 38 microns high) device. The graphs show the relatively constant signal acquired while scanning the relatively uniform bed of particles with respect to the detection in the X and Y direction (denoted by an arrow). The beam footprint was set to 75 microns (radius measured at 1/e²), resulting in the simultaneous measurement of approx. 15 beads (detection of ˜10⁻¹⁵ mole LY). This embodiment shows the possibility of relaxing the positioning accuracy requirements of the microfluidic device with respect to the optical system while still ensuring that the totality of the probed surface is overlapping with trapped particles. Note the good contrast between beads with and without grafted LY (graph on the bottom of FIG. 18A, refer to trace legend). It should be noted that beads without LY produce a non-zero background signal.

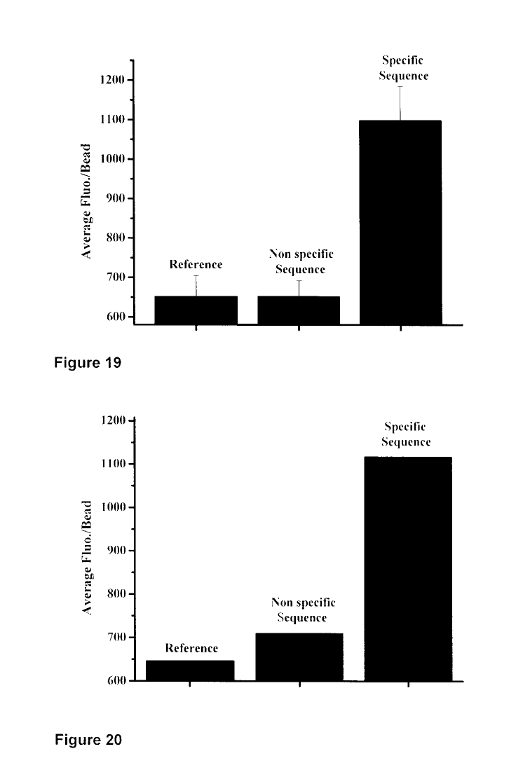

FIG. 19 shows the results obtained from an experiment further described in Example 3. With the system described in FIGS. 15A to 15C, the selective detection of genomic DNA from a sample containing endospore-forming bacteria using 2.8 micron diameter magnetic particles grafted with probe DNA (=ssDNA sequence complementary to target ssDNA sequence) and a fluorescent biosensor was successfully demonstrated. Testing of Specific Sequence (complementary ssDNA into sample), Non-specific Sequence (non-complementary ssDNA into sample) as well as Reference (no-DNA into sample) samples were performed sequentially.

Specific examples will now be given.

### Example 1

A solid state laser diode emitting at 405 nm (PointSource, iFLEX2000) used as a light source 0 is coupled to a pigtailed single mode optical fiber equipped with a collimator at the fiber end (PointSource, KineFLEX) that produces a 1 mm diameter (at 1/e²) diffraction limited beam 1 with a divergence angle of less than 0.1 mrad.

The divergence of the beam is induced by means of a pair of lenses 2, 3 (Thorlabs, f=−30 mm, LC4252 and f=75 mm, LA4725) and controlled through the spacing of the lenses. For the present demonstration, lenses were separated by 41 mm. According to FIG. 4, a lens pair separation 10 of 41 mm generates a 75 μm beam footprint (radius measured at 1/e²) at the focal plane 8 thus enabling the whole μ-EMT illumination. With such parameters, 70% of beam energy is contained within the μ-EMT diameter.

The μ-EMT consist of 75-μm diameter planar micron-scale gold conductors supported on SiO₂/Si wafers, a design previously described by Dubus et al.

The laser beam passes through a laser line interference filter 5 (Semrock, FF01-406/15-25.4-D) to clean up the excitation laser beam and get rid of any side modes that may occur in the fluorescence region of interest.

The beam is then steered by a dichroic beamsplitter 6 (Semrock, FF495-Di02-25.4-D), and is sent to the sample through a microscope objective lens 7 (Olympus, UPLFLN 4×, NA=0.13).

Fluorescence emitted from the sample is collected by the same objective lens 7. The collimated fluorescence light is steered towards the detector by the short wave pass dichroic beamsplitter 6, through a bandpass interference filter 14 of appropriate central wavelength and bandwidth (Spectra Physics, CFS-001809, 575.5 nm/20 nm) in order to block light outside the emission band of the target analyte.

A f=50 mm plano-convex lens (Thorlabs, LA1131) is then used to focus the collimated fluorescence onto a 50 micron core multimode fiber (Thorlabs, custom patch cable, NA=0.22). The core aperture plays the role of a classical confocal pinhole, while it enables a more flexible and compact detection system.

The fiber output is connected to a photon counting PMT module (Hamamatsu, Bridgewater, H7421-40). Time-integrated pulse counts were transferred to a PC running a Labview user interface for data acquisition and analysis.

The sample consists of a 25 μL droplet of water containing paramagnetic, streptavidin-functionalized microbeads (Dynal Biotech, Dynabeads M-280, 2.8-μm diameter) grafted with biotinylated Lucifer Yellow. The sample was deposited on top of the μEMT and covered by a glass coverslip which provided a flat optical surface and prevented water evaporation during the measurements. A 300 mA current was then applied to the μEMT for 5 min to attract and capture the beads. A 50 mA current was applied to the μEMT during the period of steady-state signal detection to prevent particles from moving outside the detection area.

In a preliminary experiment the detection limits of this invention reached a few tens of particles loaded with 10⁶ LY molecules/bead, which represents roughly a detection limit of 10⁻¹⁷ mole.

### Example 2

Another specific example of components usable for the selective detection of minute amounts of target genomic DNA from gram positive bacteria-containing samples, as in the illustrated embodiments of the invention includes:

A microfluidic system 20 having a combination of two different particle traps, namely a μ-EMT 22 and a weir 36 has been used for this series of experiments. The PDMS microfluidic channels 38 are 100 microns wide, 20 microns high, and the weir leaves a shallow gap in the microfluidic channel of 2 microns in height, enabling to trap small paramagnetic particles of 2.8 microns diameter while allowing the sample solution to flow through the weir.

Samples of initially approx. 500 particles grafted with probe DNA (=ssDNA sequence complementary to target ssDNA sequence) and a fluorescent biosensor were prepared and pumped into the microfluidic system through sample inlet 32 using a syringe pump 40. Particles were trapped at the weir while the solution was flown in the microfluidic channel 38 and the μ-EMT 22 set inactive. Once the particles were trapped in the weir (approx. 50 particles), fluid flow was stopped and the μ-EMT was activated, enabling confinement of the paramagnetic particles at the center of the μ-EMT. Data acquisition was performed for about 1 minute. The signal was averaged and the experiment repeated for 3 replicates, which constituted the average Reference signal and associated standard deviation depicted in FIG. 19.

Similar experiments were performed for Non-specific Sequence (non-complementary ssDNA) as well as Specific Sequence (complementary ssDNA) samples, which consisted of 5000 copies of purified and fragmented genomic dsDNA. Denaturation step (95° C.) was performed prior to mixing and hybridization (65° C.) with the probe particles. Particles were then injected into the microfluidic system. The detection of approximately 50 particles of a positive sample shows a good contrast with respect to the negative and blank samples, highlighting the very high sensitivity (i.e. approx 500 genomic DNA copies detected in the particle trap) and selectivity of such an approach.

### Example 3

Another specific example of components usable for the selective detection of minute amounts of target genomic DNA from an endospore-forming bacteria-containing samples, as in the illustrated embodiments of the invention includes:

A microfluidic system, sample preparation, sample handling, data acquisition and data analysis procedures as described in Example 2, with the exception that only one replica per sample (Specific Sequence, Non-specific Sequence and Reference) was tested.

These results, shown in FIG. 20, highlight the very high sensitivity (i.e. approx 500 genomic DNA copies detected in the particle trap) and selectivity of such an approach (good contrast with respect to the Non-specific Sequence and Reference samples). It also shows the possibility to detect, with comparable performance, different genomic DNA sequences originating from different samples. It finally shows the potential to perform rapid tests on limited sample volumes/amounts with reliable results (no need to test many replicates to obtain good precision).

1. A method of detecting a fluorescence signal emitted by a sample of fluorophores bound to particles, comprising confining said sample in a particle trap; locating said particle trap in a detection plane; directing a beam of excitation light through an objective onto said sample to trigger the emission of fluorescent light from the sample while controlling the spot diameter of said beam of excitation light in the detection plane to illuminate substantially the whole volume occupied by the sample; and detecting fluorescent light emitted by the sample with a confocal detector.

2. A method as claimed in claim 1, wherein the particle trap is located in the focal plane of the objective.

3. A method as claimed in claim 1, wherein the spot diameter of the beam of excitation light is controlled by controlling the divergence of the beam.

4. A method as claimed in claim 3, wherein the fluorescent light emitted by the fluorphores is returned via the objective back through the beam splitter to the confocal detector.

5. A method as claimed in claim 4, wherein the excitation light is passed to the objective via a dichroic beam splitter which transmits the excitation light to the sample, and the fluorescent light returned from the sample is passed back through the dichroic beam splitter to the detector.

6. A method as claimed in claim 1, wherein the spot size of the beam in the detection plane substantially equal to, or slightly less than, the size of said particle trap.

7. A method as claimed in claim 1, wherein the spot size of the beam in the detection plane is controlled by a pair of lenses inserted in the beam of excitation light and having an adjustable separation.

8. A method as claimed in claim 1, wherein said beam of excitation light is brought to a focus at a plane displaced from said detection plane by an amount sufficient to provide said spot size at in said detection plane.

9. A method as claimed in claim 1, wherein said particle trap is a μ-EMT trap, comprising a thick substrate and a thin glass plate, and wherein the beam of excitation light is directed into the particle trap from the side of the thin glass plate.

10. A method as claimed in claim 1, wherein said objective is a lens.

11. A method as claimed in claim 1, wherein the sample of interest is a small volume liquid solution containing a suspension of particle-bound fluorophores.

12. An apparatus for detecting a fluorescence signal emitted by a sample of fluorophores bound to confined particles, comprising:
a source of a beam of excitation light for triggering fluorescence of said confined particles;
a particle trap for said confined particles located in said detection plane;
an objective for directing the beam of excitation light onto said particle trap in said detection plane;
an optical control element for controlling the spot size of the beam at said detection plane such that substantially the whole volume occupied by said sample is illuminated by said excitation beam; and
a confocal detector for detecting fluorescent light emitted by the sample.

13. An apparatus as claimed in claim 12, wherein said detection plane lies in the focal plane of said objective, and said excitation beam is brought to a focus at in a plane displaced from said detection plane.

14. An apparatus as claimed in claim 12, wherein said optical control element comprises a diverging element for diverging said excitation beam to control the spot size.

15. An apparatus as claimed in claim 14, wherein said diverging element is an adjustable diverging element.

16. An apparatus as claimed in claim 15, wherein said diverging element comprises a pair of lenses with adjustable spacing.

17. An apparatus as claimed in claim 16, wherein the separation of said lenses is such that the spot size of said excitation beam at said focal plane is substantially equal to, or slightly less than, the size of said particle trap.

18. An apparatus as claimed in claim 14, wherein said diverging element is a fixed diverging element.

19. An apparatus as claimed in claim 14, wherein said diverging element comprises a tunable divergence collimator.

20. An apparatus as claimed in claim 12, further comprising a dichroic beam splitter for directing incident excitation light to said objective and returning emitted fluorescent light from said objective to said confocal detector according to the wavelength of said excitation and fluorescent light.

21. An apparatus as claimed in claim 20, wherein the optical control element is located downstream of the beam splitter whereby fluorescent light returning through the objective lens passes back through said optical control element and is focused onto an aperture of the confocal detector by an imaging lens.

22. An apparatus as claimed in claim 20, wherein the diverging element is located upstream of the beam splitter whereby fluorescent light returning through the objective lens passes back through the arrangement as a collimated beam and is focused onto an aperture of the confocal detector by an imaging lens.

23. An apparatus as claimed in claim 12, wherein said particle trap is a a microelectromagnetic trap.

24. An apparatus as claimed in claim 23, wherein said microelectromagnetic trap includes a fluidic system composed of components selected from the group consisting of: microchannels, well, reservoirs/chambers.

25. An apparatus as claimed in claim 24, wherein said fluidic system comprises a microchannel/well/reservoir/chamber arrangement located over the microelectromagnetic trap with dimensions substantially equal to the microelectromagnetic trap diameter.

26. An apparatus as claimed in claim 24, wherein said fluidic system comprises means for transporting fluids through the device to cause the liquid-suspended particle-bound fluorophores to flow in the microfluidic channel on top of the microelectromagnetic trap.

27. An apparatus as claimed in claim 25, wherein the microelectromagnetic trap is located near one surface of the microfluidic device and the microchannel/well/reservoir/chamber is located towards the interior microfluidic device.
